(19) United States
(12) Patent Application Publication
(10) Pub. No.: US 2013/0309349 A1
(43) Pub. Date: Nov. 21, 2013

(54) Mold-Tool System Having Heat-Transfer Obstruction

(71) Applicant: Paul R. Blais, South Burlington, VT (US)

(72) Inventor: Paul R. Blais, South Burlington, VT (US)

(73) Assignee: HUSKY INJECTION MOLDING SYSTEMS LTD., Bolton, ON (CA)

(21) Appl. No.: 13/981,382

(22) PCT Filed: Feb. 5, 2012
(86) PCT No.: PCT/US12/23903

§ 371 Date: Jul. 24, 2013

Related U.S. Application Data
(60) Provisional application No. 61/440,881, filed on Feb. 9, 2011.

(51) Int. Cl. B29C 45/74

(52) U.S. Cl. CPC B29C 45/74
USPC 425/549

(57) ABSTRACT

A mold-tool system (100), comprising: a manifold assembly (102); a plate assembly (104) defining a manifold-receiving space (105) receiving the manifold assembly (102); a nozzle assembly (106); a nozzle-locating assembly (108) positionally locating the nozzle assembly (106) relative to the manifold assembly (102) and to the plate assembly (104); and a heat-transfer obstruction (110) being positioned between the plate assembly (104) and the nozzle-locating assembly (108), the heat-transfer obstruction (110) being configured to obstruct transfer of heat from the plate assembly (104) toward the nozzle-locating assembly (108).

### TECHNICAL FIELD

An aspect generally relates to (but is not limited to) a mold-tool system including (but not limited to) a molding system having the mold-tool system.

### BACKGROUND

U.S. Pat. No. 7,160,101 discloses a radiant energy source for a nozzle in which the nozzle is partially transparent. The nozzle, or parts thereof, is at least partially transparent to allow radiant energy to pass therethrough.

U.S. Patent publication Number 2007/0181282 discloses an injection molding system for molding metal alloy above alloy solidus temperature.

U.S. Patent publication Number 2004/0166195 discloses an injection molding device useful for dissipating heat from a manifold comprises dissipation device having first end coupled to the manifold and second end bent towards cooling member prior to introducing heat to the manifold.

### SUMMARY

The inventors have researched a problem associated with known molding systems that inadvertently manufacture bad-quality molded articles or parts. After much study, the inventors believe they have arrived at an understanding of the problem and its solution, which are stated below, and the inventors believe this understanding is not known to the public.

A problem identified by the inventors is that a cooling layout of a mold-tool system may result in the nozzle assemblies that are located at the outer positions of a manifold assembly may be subjected to increased surface area of cooling when compared to the inner positioned nozzle assemblies or drops of the manifold assembly of a runner system. The result may be for the outer located nozzle assemblies to have smaller part weights than the inner positioned nozzle assemblies. The increased cooling to the nozzle assemblies may results in a colder operating manifold plate, which cools the nozzle housing, which reduces the plastic flow to a mold assembly.

According to one aspect, there is provided a mold-tool system, comprising: a manifold assembly; a plate assembly defining a manifold-receiving space receiving the manifold assembly; a nozzle assembly; a nozzle-locating assembly positionally locating the nozzle assembly relative to the manifold assembly and to the plate assembly; and a heat-transfer obstruction being positioned between the plate assembly and the nozzle-locating assembly, the heat-transfer obstruction being configured to obstruct transfer of heat from the plate assembly toward the nozzle-locating assembly.

Other aspects and features of the non-limiting embodiments will now become apparent to those skilled in the art upon review of the following detailed description of the non-limiting embodiments with the accompanying drawings.

### DETAILED DESCRIPTION OF THE DRAWINGS

The non-limiting embodiments will be more fully appreciated by reference to the following detailed description of the non-limiting embodiments when taken in conjunction with the accompanying drawings, in which:

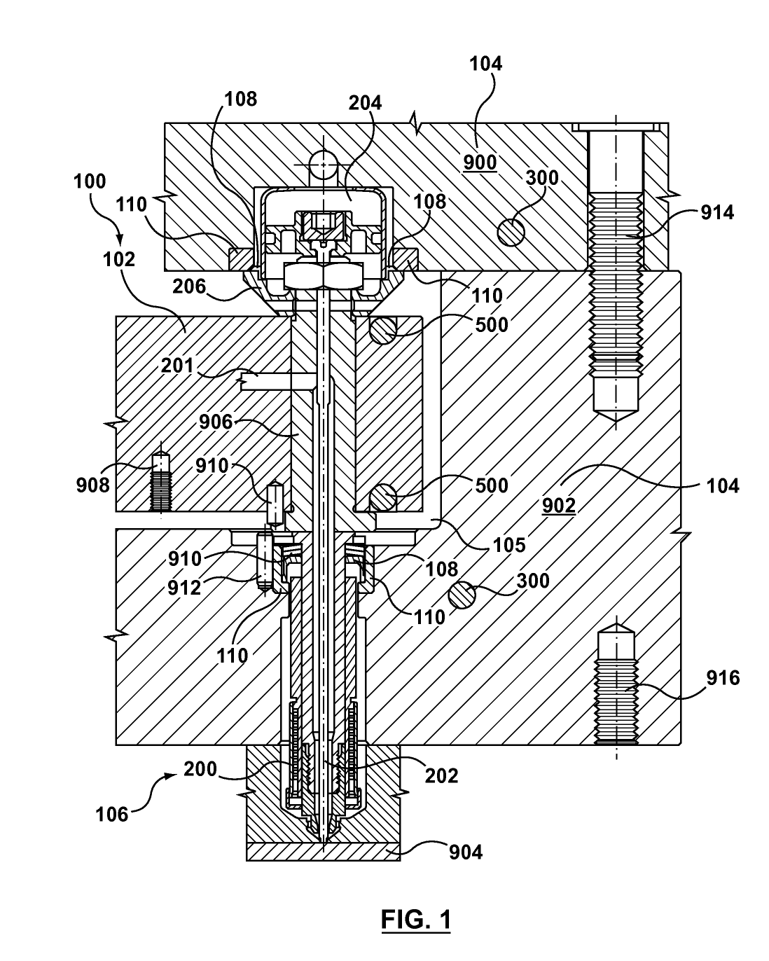

FIGS. 1, 2, 3 depict schematic representations of a mold-tool system (100).

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

### DETAILED DESCRIPTION OF THE NON-LIMITING EMBODIMENT(S)

FIGS. 1, 2, 3 depict the schematic representations of the mold-tool system (100). The mold-tool system (100) may be used in a molding system (not depicted).The mold-tool system (100) may include components that are known to persons skilled in the art, and these known components will not be described here; these known components are described, at least in part, in the following reference books (for example): (i) “Injection Molding Handbook” authored by OSSWALD/TURNG/GRAMANN (ISBN: 3-446-21669-2), (ii) “Injection Molding Handbook” authored by ROSATO AND ROSATO (ISBN: 0-412-99381-3), (iii) “Injection Molding Systems” 3^{rd} Edition authored by JOHANNABER (ISBN 3-446-17733-7) and/or (iv) “Runner and Gating Design Handbook” authored by BEAUMONT (ISBN 1-446-22672-9). It will be appreciated that for the purposes of this document, the phrase “includes (but is not limited to)” is equivalent to the word “comprising”. The word “comprising” is a transitional phrase or word that links the preamble of a patent claim to the specific elements set forth in the claim which define what the invention itself actually is. The transitional phrase acts as a limitation on the claim, indicating whether a similar device, method, or composition infringes the patent if the accused device (etc) contains more or fewer elements than the claim in the patent. The word “comprising” is to be treated as an open transition, which is the broadest form of transition, as it does not limit the preamble to whatever elements are identified in the claim.

The definition of the mold-tool system (100) is as follows: a system that may be positioned and/or may be used in an envelope defined by a platen system of the molding system (not depicted), such as an injection-molding system for example. The platen system may include a stationary platen and a movable platen that is moveable relative to the stationary platen. By way of example, the mold-tool system (100) may be included in (and is not limited to): a runner system, such as a hot runner system or a cold runner system.

Referring now to FIG. 1, the mold-tool system (100) may include (by way of example and is not limited to): (i) a manifold assembly (102), (ii) a plate assembly (104), (iii) a nozzle assembly (106), (iv) a nozzle-locating assembly (108), and (v) a heat-transfer obstruction (110). The plate assembly (104) may define a manifold-receiving space (105) that is configured to receive the manifold assembly (102). Generally, the plate assembly (104) may be configured to house and to support the manifold assembly (102). The manifold assembly (102) is a tooling system that is used to distribute a resin or melt from a melt preparation system (not depicted) to a mold assembly (904). The mold assembly (904) is used to mold and form a molded article, with assistance from other components of the molding system. The nozzle assembly (106) may be operatively connected to the manifold assembly (102). Generally, the nozzle assembly (106) may be configured to interface with the manifold assembly (102). The nozzle-locating assembly (108) may positionally locate the nozzle assembly (106) relative to the manifold assembly (102) and to the plate assembly (104). The heat-transfer obstruction (110) may be positioned between the plate assembly (104) and the nozzle-locating assembly (108). The heat-transfer obstruction (110) may be configured to obstruct transfer of heat from the plate assembly (104) toward the nozzle-locating assembly (108). The plate assembly (104) may include (by way of example and is not limited to) a backing-plate assembly (900) and manifold plate (902) that may abut the backing-plate assembly (900). The mold-tool system described above may improve balance of the manifold assembly by reducing and/or eliminating cold nozzle assemblies that are located at corner positions of or at the intersection of cooling channels that may be defined in a plate assembly.

The nozzle assembly (106) may include or may have a stem-actuation assembly (204). The plate assembly (104) may have a cooling line (300). It is understood that a cooling line (300) may be one or more cooling lines (300). A technical effect of the mold-tool system (100), amongst other effects, is that the heat-transfer obstruction (110) may improve balance of the manifold assembly (102) by reducing relative coolness of the nozzle assembly (106). A support mechanism (116), which may be also called a back-up pad, may support the nozzle-locating assembly (108) with the heat-transfer obstruction (110). The heat-transfer obstruction (110) may be configured, amongst other things, to locally reduce heat-transfer efficiency of the cooling line (300) in the plate assembly (104). A drop block (906) may be received in the manifold assembly (102). The drop block (906) may define part of the melt channel (201). A dowel 908 may be used to positional locate the manifold assembly (102) with the plate assembly (104). An orientation dowel (910) may be used to positionally orient the drop block (906) with the manifold assembly (102). A spring assembly (912) may be used to bias the nozzle assembly (106) to the manifold assembly (102). A nozzle-locating pin (913) may be used to (that is, configured to) locate the nozzle assembly (106) relative to the manifold assembly (102). A locating pin (914) may positionally locate the backing-plate assembly (900) with the manifold plate (902). A locating pin (916) may positionally locate the manifold plate (902) with the mold assembly (904).

Referring again to FIG. 1, the mold-tool system (100) may be adapted so that the nozzle assembly (106) may include (by way of example and is not limited to): (i) a nozzle-body assembly (200), (ii) a stem assembly (202), (iii) a stem-actuation assembly (204), and (iv) a support mechanism (206). The nozzle-body assembly (200) may interact with a melt channel (201) of the manifold assembly (102). The stem assembly (202) may be slidably received in the nozzle-body assembly (200). The stem-actuation assembly (204) may be operatively connected with the stem assembly (202). The support mechanism (206) may positionally support the stem-actuation assembly (204) relative to the manifold assembly (102). The support mechanism (206) may abut the heat-transfer obstruction (110). The nozzle-locating assembly (108) may be positioned between the stem-actuation assembly (204) and the heat-transfer obstruction (110).

Referring once again back to FIG. 1, the mold-tool system (100) may be further adapted such that the nozzle-locating assembly (108) may be positioned between the nozzle-body assembly (200) and the heat-transfer obstruction (110).

Referring once again back to FIG. 1, the mold-tool system (100) may be further adapted such that (i) the nozzle-locating assembly (108) may be positioned between the stem-actuation assembly (204) and the heat-transfer obstruction (110), and (ii) the nozzle-locating assembly (108) may be positioned between the nozzle-body assembly (200) and the heat-transfer obstruction (110). The manifold assembly (102) may include a header assembly (500).

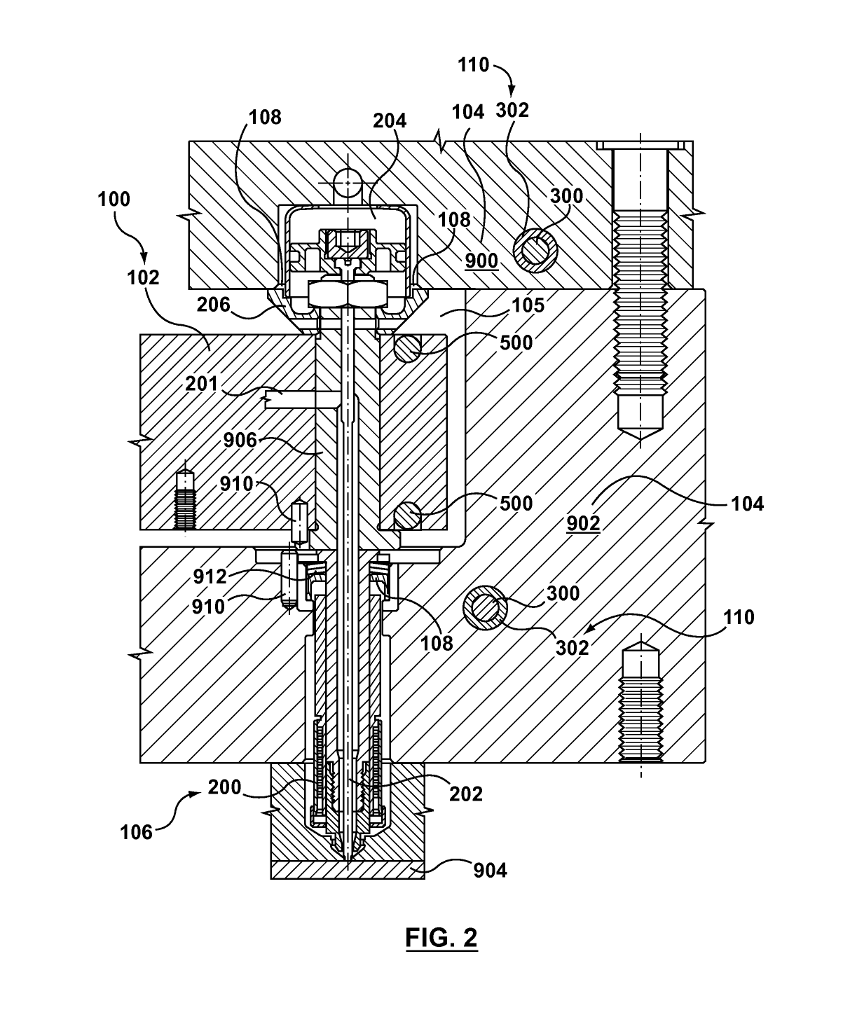

Referring now to FIG. 2, it will be appreciated that for FIG. 2, the heat-transfer obstruction (110) depicted in FIG. 1 is removed for easier understanding of the example of the mold-tool system (100) depicted in FIG. 2. According to the example depicted in FIG. 2, the mold-tool system (100) may be adapted such that the plate assembly (104) has a cooling line (300). The heat-transfer obstruction (110) may include (by way of example and is not limited to) a cooling-obstructive member (302) that may be located proximate to the cooling line (300). The cooling-obstructive member (302) may be configured to reduce a cooling efficiency the cooling line (300). A technical effect of the mold-tool system (100) depicted in FIG. 2, amongst other effects, is that the heat-transfer obstruction (110) may improve balance of the manifold assembly (102) by reducing relative coolness of the nozzle assembly (106), for the case where the nozzle assembly (106) is located proximate to a corner of an intersection of at least one cooling line (300) with at least another cooling line (300) in the plate assembly (104), for example.

Referring once again back to FIG. 2, the mold-tool system (100) may be further adapted so that the cooling-obstructive member (302) may have a thermal conductivity less than seven (7) W/mK (watts per kelvin-metre). The cooling-obstructive member (302) may be, for example (and not limited to), an insulating tube that surrounds, at least in part, the cooling line (300). The cooling-obstructive member (302) may be configured to cool down the nozzle assembly (106) that may be located at a corner position of the manifold assembly (102).

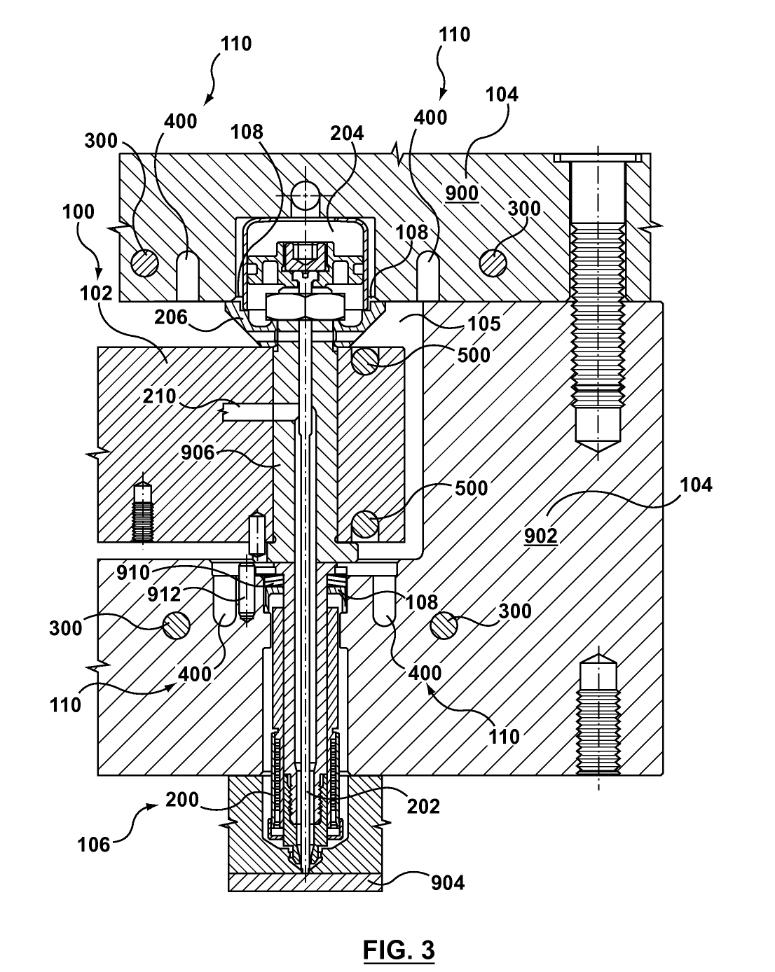

Referring now to FIG. 3, it will be appreciated that for FIG. 3, the heat-transfer obstruction (110) depicted in FIG. 1 is removed for easier understanding of the example of the mold-tool system (100) that is depicted in FIG. 3. In addition, it will be appreciated that for FIG. 3, the cooling-obstructive member (302) depicted in FIG. 2 is removed for easier understanding of the example of the mold-tool system (100) depicted in FIG. 3.

Referring once again to FIG. 3, the heat-transfer obstruction (110) may include (by way of example and is not limited to) an insulation pocket (400). The insulation pocket (400) may be defined by the plate assembly (104). The insulation pocket (400) may be positioned between the cooling line (300) and the nozzle-locating assembly (108). The insulation pocket (400) may be configured to locally reduce heat transfer from the cooling line (300) to the nozzle-locating assembly (108).

According to one option, the insulation pocket (400) may be positioned proximate to the nozzle-body assembly (200). According to another option, the insulation pocket (400) may be positioned proximate to the stem-actuation assembly (204). According to another option, (i) the insulation pocket (400) may be positioned proximate to the nozzle-body assembly (200), and (ii) the insulation pocket (400) may be positioned proximate to the stem-actuation assembly (204). The insulation pocket (400) may also be called a cut out. The insulation pocket (400) may be any one of a thru pocket and a blind pocket and a combination thereof.

It will be appreciated that the mold-tool system (100) may be adapted, for example and not limited to) the following arrangement: the heat-transfer obstruction (110) may include (by way of example and is not limited to) all of the following components in combination: (i) the cooling-obstructive member (302), and (ii) the insulation pocket (400).

It will be appreciated that installation of plastic tubes in the cooling line (300) may be used (or may be configured) to reduce the cooling efficiency of a corner drop (nozzle assembly). The tube may be installed to a block or reduce cooling to a corner drop—that is a nozzle assembly that may be located at a corner position of the manifold assembly (102). The insulation pocket (400) or the insulation pockets (400) may be configured to block or reduce heat transfer from the nozzle assembly to a header. The insulator spacer may be positioned between the header lines and the plate to thermally insolate the headers from the nozzle assemblies.

It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) description provided outside of this document (that is, outside of the instant application as filed, as prosecuted, and/or as granted). It is understood, for the purposes of this document, the phrase “includes (and is not limited to)” is equivalent to the word “comprising”. It is noted that the foregoing has outlined the non-limiting embodiments (examples). The description is made for particular non-limiting embodiments (examples). It is understood that the non-limiting embodiments are merely illustrative as examples.

What is claimed is:

1. A mold-tool system (100), comprising:
a manifold assembly (102);
a plate assembly (104) defining a manifold-receiving space (105) receiving the manifold assembly (102);
a nozzle assembly (106);
a nozzle-locating assembly (108) positionally locating the nozzle assembly (106) relative to the manifold assembly (102) and to the plate assembly (104); and
a heat-transfer obstruction (110) being positioned between the plate assembly (104) and the nozzle-locating assembly (108), the heat-transfer obstruction (110) being configured to obstruct transfer of heat from the plate assembly (104) toward the nozzle-locating assembly (108).

2. The mold-tool system (100) of claim 1, wherein:
the nozzle assembly (106) includes:
a nozzle-body assembly (200) interacting with a melt channel (201) of the manifold assembly (102);
a stem assembly (202) being slidably received in the nozzle-body assembly (200); and
a stem-actuation assembly (204) being operatively connected with the stem assembly (202); and
a support mechanism (206) positionally supporting the stem-actuation assembly (204) relative to the manifold assembly (102), the support mechanism (206) abutting the heat-transfer obstruction (110), and
the nozzle-locating assembly (108) being positioned between the stem-actuation assembly (204) and the heat-transfer obstruction (110).

3. The mold-tool system (100) of claim 1, wherein:
the nozzle assembly (106) includes:
a nozzle-body assembly (200) interacting with a melt channel (201) of the manifold assembly (102);
a stem assembly (202) being slidably received in the nozzle-body assembly (200); and
a stem-actuation assembly (204) being operatively connected with the stem assembly (202); and
the nozzle-locating assembly (108) being positioned between the nozzle-body assembly (200) and the heat-transfer obstruction (110).

4. The mold-tool system (100) of claim 1, wherein:
the nozzle assembly (106) includes:
a nozzle-body assembly (200) interacting with a melt channel (201) of the manifold assembly (102);
a stem assembly (202) being slidably received in the nozzle-body assembly (200); and
a stem-actuation assembly (204) being connected with the stem assembly (202); and
a support mechanism (206) positionally supporting the stem-actuation assembly (204) relative to the manifold assembly (102), the support mechanism (206) abutting the heat-transfer obstruction (110), and
the nozzle-locating assembly (108) being positioned between the stem-actuation assembly (204) and the heat-transfer obstruction (110), and
the nozzle-locating assembly (108) being positioned between the nozzle-body assembly (200) and the heat-transfer obstruction (110).

5. The mold-tool system (100) of claim 1, wherein:
the plate assembly (104) has a cooling line (300); and
the heat-transfer obstruction (110) includes:
a cooling-obstructive member (302) being located proximate to the cooling line (300), the cooling-obstructive member (302) being configured to reduce a cooling efficiency the cooling line (300).

6. The mold-tool system (100) of claim 1, wherein:
the plate assembly (104) has a cooling line (300); and
the heat-transfer obstruction (110) includes:
a cooling-obstructive member (302) being located proximate to the cooling line (300), the cooling-obstructive member (302) being configured to reduce a cooling efficiency the cooling line (300), the cooling-obstructive member (302) having a thermal conductivity less than seven watts per kelvin-metre.

7. The mold-tool system (100) of claim 1, wherein:
the plate assembly (104) has a cooling line (300); and
the heat-transfer obstruction (110) includes:
an insulation pocket (400) being defined by the plate assembly (104), the insulation pocket (400) being positioned between the cooling line (300) and the nozzle-locating assembly (108), the insulation pocket (400) being configured to locally reduce heat transfer from the cooling line (300) to the nozzle-locating assembly (108).

8. The mold-tool system (100) of claim 7, wherein:
the insulation pocket (400) is positioned proximate to a nozzle-body assembly (200).

9. The mold-tool system (100) of claim 7, wherein:
the insulation pocket (400) is positioned proximate to a stem-actuation assembly (204).

10. The mold-tool system (100) of claim 1, wherein:
the manifold assembly (102) includes a header assembly (500);
the plate assembly (104) has a cooling line (300); and
the heat-transfer obstruction (110) includes:
a cooling-obstructive member (302) being located proximate to the cooling line (300), the cooling-obstructive member (302) being configured to reduce a cooling efficiency the cooling line (300);
an insulation pocket (400) being defined by the plate assembly (104), the insulation pocket (400) being positioned between the cooling line (300) and the nozzle-locating assembly (108), the insulation pocket (400) being configured to locally reduce heat transfer from the cooling line (300) to the nozzle-locating assembly (108).

11. The mold-tool system (100) of claim 1, wherein:
the nozzle assembly (106) includes:
a nozzle-body assembly (200) interacting with a melt channel (201) of the manifold assembly (102);
a stem assembly (202) being slidably received in the nozzle-body assembly (200); and
a stem-actuation assembly (204) being connected with the stem assembly (202); and
a support mechanism (116) positionally supporting the stem-actuation assembly (204) relative to the manifold assembly (102), the support mechanism (116) abutting the heat-transfer obstruction (110), and the nozzle-locating assembly (108) being positioned between the stem-actuation assembly (204), and the heat-transfer obstruction (110), and
the nozzle-locating assembly (108) being positioned between the nozzle-body assembly (200) and the heat-transfer obstruction (110);
the manifold assembly (102) includes a header assembly (500);
the plate assembly (104) has a cooling line (300); and
the heat-transfer obstruction (110) includes:
a cooling-obstructive member (302) being located proximate to the cooling line (300), the cooling-obstructive member (302) being configured to reduce a cooling efficiency the cooling line (300);
an insulation pocket (400) being defined by the plate assembly (104), the insulation pocket (400) being positioned between the cooling line (300) and the nozzle-locating assembly (108), the insulation pocket (400) being configured to locally reduce heat transfer from the cooling line (300) to the nozzle-locating assembly (108).
